(19) United States
(12) Patent Application Publication
(10) Pub. No.: US 2005/0257197 A1
(43) Pub. Date: Nov. 17, 2005

(54) Role-based object models

(76) Inventors: Klaus Herter, Leimen (DE); Wolfgang Kalthoff, Bad Schoenborn (DE); Jens Staeck, Sandhausen (DE)

Correspondence Address: FISH & RICHARDSON, P.C., PO BOX 1022, MINNEAPOLIS, MN, 55440-1022, US

(21) Appl. No.: 10/931,225

(22) Filed: Sep. 1, 2004

Related U.S. Application Data
(60) Provisional application No. 60/569,603, filed on May 11, 2004.

(51) Int. Cl. G06F 9/44

(52) U.S. Cl. 717/116

(57) ABSTRACT

A data management system is described for managing software objects to provide services and functionality to users in an efficient manner. The system separates objects from roles associated with the objects, so that applications accessing the system interface only with the roles, rather than with the objects. The roles each provide a functionality to the applications that may be common to multiple ones of the objects. The roles may be tailored to specific accessing applications, without affecting the objects themselves. As a result, the applications may easily gain a desired functionality or behavior by accessing the appropriate role.

### CLAIM OF PRIORITY

This application claims priority under 35 USC § 119(e) to U.S. Patent Application Ser. No. 60/569,603, filed on May 11, 2004, and titled “OBJECT IMPLEMENTATION MODEL FOR GLOBAL TRADE APPLICATIONS.”

### TECHNICAL FIELD

This description relates to object-oriented programming.

### BACKGROUND

Conventional techniques exist for implementing object-oriented programs. In this context, objects refer to self-contained, discrete software entities that include both data and/or methods to manipulate the data. The software entities may correspond to one or more real-world entities, such as, for example, a person or group of persons, a product, a business or organizational unit of a business, or a class of persons (e.g., customers, suppliers, manufacturers, or business partners).

In some systems, objects may be accessed by other programs or applications, and these programs or applications may thus use the functionality of the object to achieve a desired goal. In so doing, the programs or applications may gain certain advantages, and may, for example, avoid the costly and time-consuming task of creating, or re-creating, the functionality that is already present within the accessed object.

### SUMMARY

According to one general aspect, an apparatus includes a storage medium having instructions stored thereon. The instructions include a first code segment for maintaining a plurality of software objects, including an object representing an abstraction of an entity and having a plurality of object attributes that characterize the object and the entity, a second code segment for maintaining a plurality of roles, including a role having a plurality of role attributes derived from the object attributes based on requirements of a requesting application, and operable to provide a functionality to the requesting application to fulfill the requirements, and a third code segment for receiving a request from the requesting application at the role and providing the functionality to the requesting application, using the role and independently of any interaction between the object and the application.

Implementations may include one or more of the following features. For example, the apparatus may include a fourth code segment for maintaining relationship information describing relationships between the objects and the roles, based on the object attributes and the role attributes.

The apparatus may include a fourth code segment for adding additional role attributes to the role attributes, independently of the object attributes and based on the requirements of the requesting application, or may include a fourth code segment for modifying the role attributes, independently of the object attributes and based on the requirements of the requesting application.

The apparatus may include a fourth code segment for modifying the object attributes, independently of the role attributes, or a fourth code segment including persistence rules for maintaining the object across multiple sessions. In the latter case, the apparatus may include a fifth code segment for modifying a selected one of the roles independently of the persistence rules.

The apparatus may include a fourth code segment for maintaining an object model that organizes and defines the objects. All interaction between the software objects and the application may occurs through the roles.

According to another general aspect, an object representing an abstraction of an entity and having a plurality of object attributes characterizing the object and the entity is input. A role is defined by deriving role attributes from the object attributes, based on requirements of an application, and a service is provided to the application to fulfill the requirements, using the role and independently of any communication between the object and the application.

Implementations may include one or more of the following features. For example, in providing the service, a request may be received from the application at the role. The object may be accessed to obtain object attribute information, and the service may be provided to the application, based on the object attribute information. In this case, accessing the object may include selecting the object from among a plurality of objects that are associated with the role, which may itself include determining required object attributes required by the role to provide the service to the application.

Alternatively, accessing the object may include invoking the object according to persistence rules associated with the object. In this case, in providing the service to the application, the role may be maintained separately from the persistence rules associated with the object.

Additional role attributes may be added to the role attributes, independently of the object attributes and based on the requirements of the application. The role attributes may be modified, independently of the object attributes and based on the requirements of the application. The object attributes may be modified, independently of the role attributes. Also, in providing the service, all communication may be conducted between the object and the application through the role.

According to another general aspect, a system includes an object modifier operable to modify object attributes of an object selected from among a plurality of objects that represent abstractions of entities, and a role modifier operable to modify role attributes, wherein the role attributes partially define a role interface for interfacing with an application to provide a service to the application, independently of communications between the object and the application.

Implementations may include one or more of the following features. For example, the role modifier may be operable to modify the role attributes based on requirements of the application for providing the service to the application. In this case, the role modifier may be operable to derive the role attributes from the object attributes, based on the requirements. The object modifier may be operable to modify the objects independently of the roles, and the role modifier may be operable to modify the roles independently of the objects.

The system may include a master data management system that is operable to provide an object model that includes the objects and the roles and that enables a common use of the objects or the roles to a plurality of applications or systems. In this case, the master data management system may include a content consolidator that is operable to consolidate objects uploaded from the systems or applications, and a harmonizer that is operable to ensure consistency of data within the objects or the roles, throughout the systems or applications.

The details of one or more implementations are set forth in the accompanying drawings and the description below. Other features will be apparent from the description and drawings, and from the claims.

### DESCRIPTION OF DRAWINGS

FIG. 1 is a block diagram of a data management system.

FIGS. 2A and 2B are block diagrams illustrating uses of objects in the data management system of FIG. 1.

FIG. 3 is a block diagram of a master data management system.

FIG. 4 is a flowchart illustrating operations of the data management systems of FIGS. 1 and 3.

### DETAILED DESCRIPTION

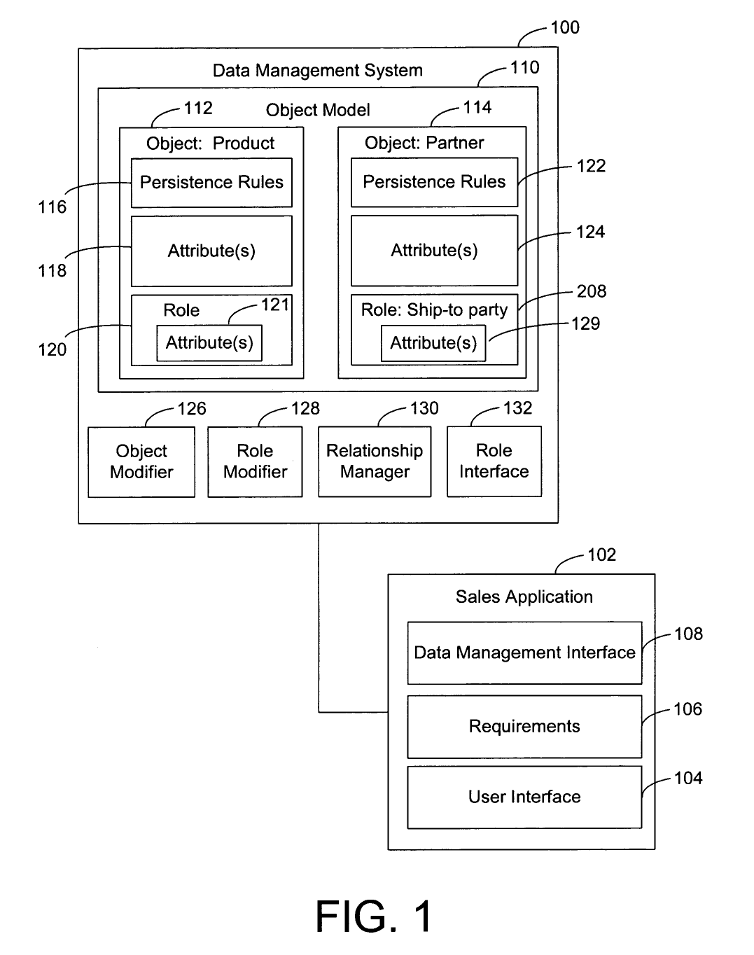

FIG. 1 is a block diagram of a data management system 100. The data management system 100 may represent, for example, a system for storing or manipulating business data, such as, for example, customer data, sales data, or inventory data. As such, the system 100 may represent a Customer Relationship Management (CRM) system, a Supply Chain Management (SCM) system, a Human Resources (e.g., employee management) System, or any other type of system used in the successful operation of a business interest. Of course, the system 100 also may represent a system for managing virtually any other type of data besides business data, such as, for example, educational resources used by schools, charitable donations used by non-profit organizations, or government data.

In storing and manipulating data and resources in the various settings just discussed, and in other settings, the system 100 generally provides functionality to an application that makes use of the data and resources to achieve a desired outcome. In FIG. 1, for example, a sales application 102 accesses the data management system 100, in order to implement various services, behaviors, and/or features associated with initiating, conducting, or completing a sale to a customer. For example, the sales application 102 may interface with a web service that runs at the data management system 102.

For example, the sales application 102 may be used to enter a customer's order information (e.g., type of product or service to be purchased, delivery information, or payment information). Such information may be entered by way of a user interface 104, so as to meet requirements 106 of the sales application 102 that specify the types and amount of information needed with respect to the sale or potential sale to the customer.

Although it is possible that the sales application 102 may include some or all of the behavior necessary to implement the requirements 106, FIG. 1 illustrates a scenario in which the sales application 102 accesses the data management system 100, using an data management interface 108, in order to implement at least some of the required behavior of the requirements 106, and/or to synchronize data entered by way of the user interface 104 with data that is contained in, or associated with, the data management system 100.

For example, the sales application 102 may be running at a site that is remote from the data management system 100, where the site may be one of a number of retail sales locations associated with a particular business. As another example, the sales application 102 may be publicly available to potential customers over a public network, such as, for example, the Internet.

Operation of the sales application 102 may, therefore, have various non-local effects, some of which may be affected by the data management system 100 (and others of which may not be related to use of the data management system 100). For example, when a sale occurs, inventory databases may need to be updated at a remote warehouse(s), and/or an order to a manufacturer may need to be placed to replenish a sold item. Of course, the sales application 102 may represent a large number of remote sales applications (or other applications) that interact with the data management system 100, so that such a centralized data management system may efficiently facilitate an operation and administration of all such applications.

Thus, a computing power required by the sales application 102, as well as maintenance of (and modification to) the sales application 102, may be lessened by the reliance of the sales application 102 on the data management system 100, and by a centralized nature of the data management system 100. For example, the sales application 102 may be running on a mobile device with limited computing resources, and may use the data management system 100 to implement a wider range of functionality than if the sales application 102 were self-contained. Further, to the extent that functionality of the sales application 102 is implemented using the data management system 100, any repairs or modifications of this functionality may be performed at the data management system 100, to the benefit of the sales application 102 (and any other applications accessing the data management system 100).

In providing services and behavior to the sales application 102, the data management system 100 employs an object model 110 that includes objects that are represented in FIG. 1 by an object 112 and an object 114. Generally speaking, an object model such as the object model 110 represents a graphical depiction of a structure of its objects, e.g., the objects 112 and 114, and includes, for example, the identity, attributes, functionality, and (dynamic or static) relationships between the objects.

As referred to above, the objects 112 and 114, and any other objects within the object model 110, generally represent or correspond to abstractions of existing entities, where the entities are independent of particular processes. For example, the object 112 is a “product” object, that represents a particular product (e.g., goods or services for sale), while the object 114 is a “partner” object, and represents an abstraction of an entity (e.g., a person, business, or organizational unit) with which the sales application 102 may interact.

With respect to the product object 112, then, the object model 110 would include data and methods associated with the represented product, as well as the relationships between the product object 112 and other objects. For example, the object model 110 may specify that a the product object 112 associated with a particular computer for sale at a retail location must contain attributes such as a price, description, and location of the computer(s) for sale. The object model 110 may further specify a relationship between the product object 112 and the partner 114, such as, for example, that the represented product may be ordered from, or shipped to, the entity represented by the partner object 114.

Thus, the object model 110 provides a conceptual representation of a business domain of the data management system 100 and associated applications (e.g., the sales application 102), and embodies the business rules that the data management system 100 seeks to implement and automate. The object model 110 may be represented with a class diagram, so that the associated objects may be organized, perhaps hierarchically, into pre-assigned classes or groups. By treating the objects 112 and 114 as discrete entities, the sales application 102 or other client application may gain access to data and functionality associated with the object(s).

When multiple functionalities are implemented by a given one of the objects 112 and 114, the sales application 102 may require knowledge to determine which of the objects to invoke to obtain the functionality. For example, if the sales application 102 seeks to ship an item to a receiving party (referred to as a “ship-to” party), there may be several entities (i.e., objects) to which an item may be shipped.

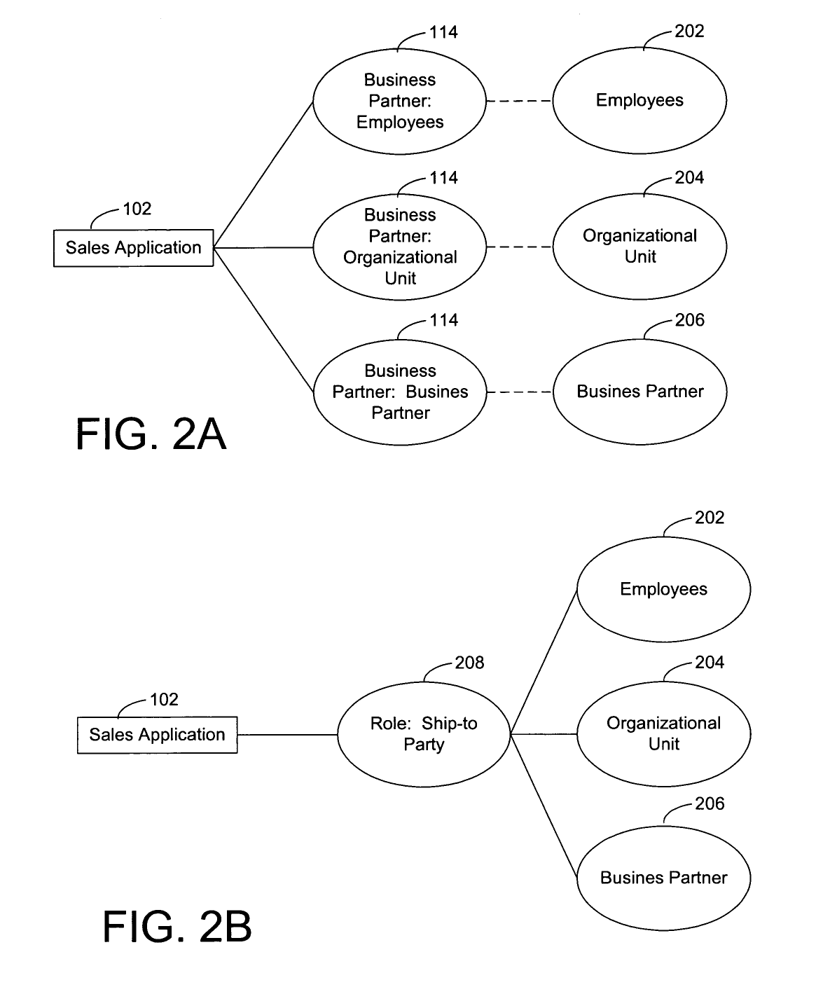

Thus, the object model 110 may be devised such that its objects each provide a large number of functionalities, so that the sales application 102 need be aware of only a relatively few objects. FIG. 2A illustrates such a scenario, in which the partner object 114 represents all possible “ship-to” parties of an employee 202, an organization unit 204, and a business partner 206. When the sales application 102 desires to specify a ship-to party, it may call the partner object 114, and, in that context, obtain the desired shipping functionality.

As a result, however, the partner object 114 may become overly complex, and may be called and/or modified a relatively large number of times. Moreover, when the partner object 114 is used or modified in the context of specifying a ship-to party such as the employee 202, undesired changes may incidentally be made to the object 114 in the context of the organization unit 204.

On the other hand, the object model 110 may be devised such that its objects each provide only a relatively small number of functionalities, i.e., services and/or behaviors. In this case, the objects may be simple and robust, and a number of times that each object is called may be lessened. However, in this case, it may be difficult for the sales application 102 to have, or maintain knowledge of, all of the various objects in an efficient manner.

Further, the sales application 102 may implement its own object model, with associated objects. In this case, maintaining alignment and synchronization between the sales application 102 and the data management system 100 may be problematic, due to incompatibilities between the object model 110 of the data management system 100 and the object model of the sales application 102, regardless of how the object model 110 of the data management system 100 is constructed.

FIG. 2B illustrates a separate technique by which the sales application 102 may access services or behavior for selecting a ship-to party. Specifically, in FIG. 2B, a role 208 is provided that embodies the functionality of the ship-to party, regardless of whether the role 208 is associated with the employees object 202, the organizational unit object 204, or the business partner object 206. Thus, the sales application may only have knowledge of the role 208 in order to specify shipping features, and may not require specific knowledge of objects associated with the role 208.

In this way, objects in the object model 110 may be kept simple and robust, since, even if the objects are relatively large in number, the sales application 102 is not required to have knowledge of all of the objects. Rather, as just explained, the sales application 102 may know only that it requires functionality associated with the role 208 of ship-to party, and may thus call the role 208, rather than any specific object.

In contrast, in the example of FIG. 2A, an application that directly requests an object may be presented with an object interface that includes a large number of attributes, some of which may not be useful to the requesting application (and some of which may not be useful to any application, but may merely exist because they were previously useful, but were never removed when their use was eliminated). Thus, the application would have to know which object to invoke, and how to invoke the object (e.g., which attributes are required). Moreover, during updates to the objects in such settings, it may be difficult to ascertain which of the object's attributes are used by particular applications, or even if the attributes are used at all. As a result, changes to the object may have unforeseen and undesired effects on certain applications.

Returning to FIG. 1, the object model 110 illustrates a structure of the data management system 100 by which the features of FIG. 2B may be obtained. Specifically, the object 112 contains persistence rules 116, attributes 118, and a role 120. Similarly, the partner object 114 contains persistence rules 122, attributes 124, and the role 208 associated with functionality of the partner object 114 as a party to whom an item is to be shipped.

The persistence rules 116 and 122 generally refer to the capability of the objects 112 and 114, respectively, to exist beyond a time during which it is created or used. For example, the product object 112 may persist before, during, and after a time in which a particular instantiation of the product object 112 is used by the sales application 102, or across times of specific sessions initiated by the sales application 102. Persistency generally includes aspects of, for example, data storage and retrieval, maintaining consistency of class descriptions, and maintaining relationships between the objects 112 and 114 and other objects.

The object attributes 118 and 124, as referred to above, refer generally to non-changing, descriptive aspects of the entities to which the objects 112 and 114 correspond. Attributes may include, for example, descriptive features of the entity of which the objects 112 and 114 are abstractions, business processes in which the entities or involved, or intended uses of the entities. For example, attributes of the product object 112 may include descriptions of the products weight, its packaging, or its intended price or target market. To the extent that the attributes 118 and 124 do not change, it should be understood that their existence and operations may be governed according to the persistence rules 116 and 122, respectively.

The roles 120 and 208 may be derived from their respective objects 112 and 114. For example, the product object 112 may have certain attributes, such as, for example, a Uniform Purchase Code (UPC) bar code, a target market, and price or tax information associated with sale of the associated product. Thus, the role 120 may have some or all of these attributes, and, moreover, may have different or additional attributes beyond the attributes of the product object 112.

Techniques for deciding which object attributes are assigned to which role(s) are discussed in more detail below. Generally speaking, however, it may be advantageous to assign attributes based on the requirements 106 of the application 102. In such cases, the roles provide a contract between the application 102 and their respective objects. As a result, the application 102 is aware of which role to call when the application 102 requires a specific service or behavior.

Moreover, a provider of the data management system 100 itself may be aware of which (role) attributes are used by which applications. As a result, attributes may be more easily managed. For example, attributes that are not used by any application may be eliminated. As another example, changes to a role's attributes will impact only those (known) applications that make use of the role, so that modification of the role's attributes may be made more easily and efficiently, without undue concern for inadvertent effects on marginally-related applications.

For example, it may be the case that the data management system 100 is provided or sold to a party for the purpose of managing that party's existing data. For example, a business may implement the data management system 100 in order to consolidate and synchronize sales data across a number of platforms, locations, and users. In such cases, the business may have a pre-existing object model that is already associated with its operations, so that modifications to the object model 110 of the data management system 100 may be required in order to conform the object model 110 to the existing object model of the business.

In the data management system 100, an object modifier 126 is included for the purpose of altering the objects 112 and 114, so as to, for example, conform the objects to an existing object model, or to upgrade the objects 112 and 114 to match other system upgrades. However, in FIG. 1, a need for such modifications may be reduced or eliminated, since modification may be made to the roles 120 and 208, rather than to the objects 112 and 114 (or their object attributes 118 and 124) directly.

Accordingly, a role modifier 128 is included that may be used to modify properties associated with the roles 120 and 208, or to define new roles to be associated with the objects 112 and 114, or with other objects, as needed. The role modifier 128 also may be used to create new roles. For example, the role modifier 128 may initially create the role 120 by assigning role attributes 121, either from among attributes 118, and/or from additional attributes specified by the requirements 106 of the application 102. Similarly, the role modifier 128 may create the role 208 by assigning role attributes 129 from among the object attributes 124, or by adding additional attributes specific to the requirements 106 of the application 102.

When used to update or otherwise modify a role, the role modifier 128 will generally consider the role in conjunction with the application(s) that will be interfacing with the role, so that the role (and its role attributes) is compatible with those application(s) and the requirements of the application(s). Moreover, by considering the applications that will interface with the updated roles, the data management system 100 is able to track which applications use which (role) attributes.

A relationship manager 130 governs the existence and modifications of relationships between the roles, including the roles 120 and 208. In some implementations of the data management system 100, all relationships within the object model 110 are defined as relationships between roles, so that relationships may therefore be upgraded or modified with respect to the various roles. As such, modifications to relationships between objects, if any such relationships are used, may be minimized.

Relationships managed by the relationship manager 130 may refer to, for example, shared attributes between the objects 112 and 114 and their roles 120 and 208, respectively. For example, the object attributes 118 of the object 112 may strongly overlap with the role attributes 121, while the object attributes 124 of the object 114 may only marginally overlap with the role attributes 129.

Further, shared attributes between an object and its roles may be used by the relationship manager 130 to validate data within the objects and their roles. For example, if the object 114 contains attributes 124 that are shared with the role attributes 129, then the shared attributes may be used to ensure that data stored in association with the attributes is synchronized within the two different settings (or at least, that a workflow is initiated for determining whether the data should, in fact, be synchronized).

Finally with respect to FIG. 1, the data management system 100 uses a role interface 132 through which the data management interface 108 accesses a desired one of the roles. As already explained, one benefit of this construction is that the sales application 102 need not be aware of which objects exist within the object model 110, or of how to invoke or interface with such objects. Rather, the sales application 102 may use the role interface 132 to interact with a desired role, such as the “ship-to party” role of the partner object 114, without even knowing which object sits behind the role and assists in implementing the functionality thereof. As a result, in some implementations, objects may be substituted for one another without having an effect on the operations of the sales application 102.

As explained with respect to FIGS. 1 and 2A-2B, the data management system 100 makes use of an entity referred to herein as a role, which defines an aspect of the semantics and functionality of an associated object, so that, in effect, the total semantics of a particular object includes the sum of its roles. Interactions, relationships, and interfaces may be defined with respect to the roles, rather than with respect to the objects, while persistence is defined with respect to, and implemented by, the objects themselves.

Thus, the data management system 100 provides flexibility to users for modifying the roles, without modifying the associated objects or object model. Moreover, designers and users of the data management system 100 may flexibly define the object model 110 to include relatively simple and robust objects, since each object is not forced to provide all functionality for all applications that may call that object. Rather, each object may provide an abstraction of a single and simple real-life entity, and use (i.e., be related to) only those roles needed to provide desired functionality requested by particular applications.

Although FIG. 1 illustrates that the roles 120 and 208 are contained within their respective objects 112 and 114 in a one-to-one relationship, it should be understood that the relationship manager 130 may manage relationships between the objects and roles in a number of different manners. For example, a role may be associated with more than one object, and with references (e.g., pointers) maintained between the role and the associated objects.

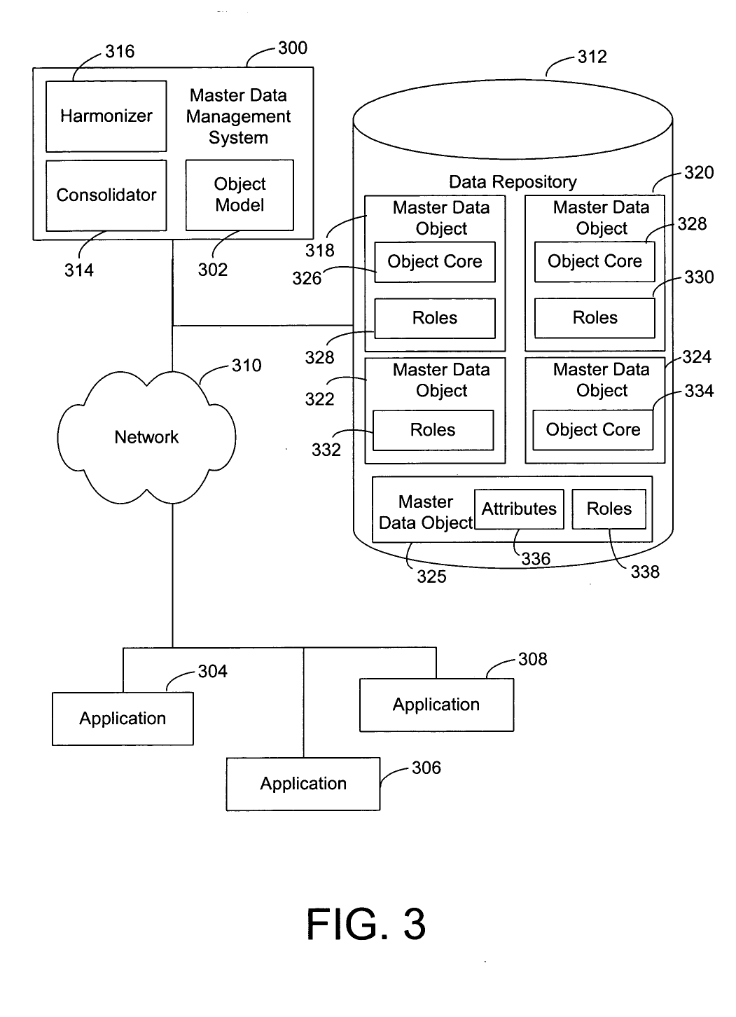

FIG. 3 is a block diagram of a master data management system 300, providing an implementation of the data management system 100 of FIG. 1. In FIG. 3, the master data management system 300 is generally designed to enable companies to consolidate and harmonize product data in a heterogeneous system landscape.

For example, a company may take part in a merger or acquisition in which another company's (different) computer systems must be integrated with existing systems. As another example of a heterogeneous system landscape, it may be the case that different entities or subsidiaries within a larger corporate landscape purchase different systems, or upgrade their respective systems at different times, or in different ways.

As a result, companies may be unable to efficiently track or gather data within their organization. For example, a company may not be able to compare prices from different vendors, since internal users of the vendors may track or report vendor interactions differently from one another. As another example, the company may not be aware that different subsidiaries are using a particular vendor, and may therefore miss an opportunity to negotiate for preferred purchasing terms.

Accordingly, the master data management system 300 of FIG. 3 may be used for, for example, efficient inventory management, collection of customer data, determination of synergy parts, and streamlined purchasing, as well as many other arenas in which uniform data management may benefit the company as a whole. In short, the master data management system 300 of FIG. 3 is designed to allow a company or other organization to aggregate, map, exchange, analyze, and disseminate master data, at a business object level and on a global scale, using existing information technology infrastructure.

In providing these features and benefits, the master data management system 300 includes an object model 302 that may apply throughout some or all of the system landscape, so that object definitions and dependencies may generally be maintained in a centralized location. In FIG. 3, the system landscape includes applications 304, 306, and 308, which are in communication with the master data management system 300 by way of a network 310, and which may be running on different (types or versions of) systems from one another.

In some instances, when one of the applications 304, 306, or 308 interacts with the master data management system 300 (e.g., to upload objects thereto), the specific application may be referred to as a “master data client.” Similarly, when the master data management system interacts with one of the applications or their respective systems (e.g., to ensure consistency between objects of the different systems, as discussed in more detail below), the master data management system may be referred to as a “master data server.”

The master data management system 300 provides a centralized data repository 312 for data maintenance, and may therefore reduce or eliminate local maintenance by updating client systems running the applications 304, 306, and 308 with a copy of master data. As a result, among other benefits, the master data management system 300 helps an organization ensure a brand identity of its products, and enforce consistent product specifications throughout the organization.

The master data management system 300 also includes a content consolidator 314, which is designed to consolidate master data objects from the various different systems. For example, different subsidiaries or systems within the system landscape may identify customers or products differently from one another, so that it becomes difficult to determine how many unique customers have recently interacted with the organization as a whole. That is, the repository 312 may suffer from duplication or omission of such information. The consolidator 314 conforms the information to the standard of the object model 302, and may then transfer the consolidated information to the data repository 312 or other location, for access and use throughout the organization.

A harmonizer 316 is used to ensure consistency of the data within the objects of the object model 302, throughout the organization. For example, even if all data within the repository 312 has been aggregated and consolidated, it may be the case that a user of a particular application 304 makes a modification to a system running the application 304. This modification must be reflected throughout, i.e., harmonized with, the other data within the repository 312.

For example, if a user of the application 304 indicates that a particular vendor should no longer be used, the harmonizer 316 seeks to ensure that this information is consistent within the repository 312, or otherwise available throughout the organization, so that other users do not inadvertently use the undesirable vendor. In other words, the harmonizer 316 is operable to ensure that consolidated master data is harmonized within the system landscape by way of consistent maintenance and distribution of the master data.

As referred to above with respect to FIG. 1, when an organization implements the master data management system 300, or when a new or modified system is added to the system landscape, the object model 302 of the master data management system 300 may be at odds with an object model of the existing, new, or modified system(s). Moreover, even if the object models are similar or interoperable with one another, a size or complexity of the master data management system 300 (or of the applications 304, 306, 308 accessing the master data management system 300), may suggest the use of complex or cumbersome objects, and/or of complex or cumbersome interfaces for accessing those objects.

As a result, and in accordance with the features and benefits of the data management system 100 of FIG. 1, roles may be implemented in conjunction with the objects of the object model 302. As explained, such roles may be used to minimize the complexity of the associated objects, and to minimize the information needed by the applications 304, 306, and 308 to interface with desired attributes.

In particular, as shown in FIG. 3, the repository 312 includes master data objects 318, 320, 322, 324, and 325. The master data object 318 includes an object core 326, which may include attributes of the object 318, as well as rules governing the persistence of the object 318. Further, the master data object 318 includes a role or roles 328, with which the applications 304, 306, and 308 may interact to obtain a desired functionality. Similarly, the master data object 320 includes an object core 328 and roles 330.

Also within the repository 312, the master data object 322 includes role(s) 332, without necessarily containing a separate object core. For example, the role 332 may perform some function that need not be associated with a persistent object. As another example, the role 332 may perform a function that may be associated with a number of different master data objects (including the master data objects 318 or 320), and, as such, may be associated with each of these master data objects, but not separately stored with (e.g., duplicated to) each of them.

Conversely, the master data object 324 may include an object core 334, without including any defined roles. In this case, the object 324 may simply represent a conventional object that is not associated with any role. For example, if the object 324 is accessed only by a particular application, or is only used to provide a limited functionality, it may be redundant or inefficient to include a separate role. Additionally, or alternatively, the object 324 may be associated with (e.g., linked to) a role (such as, for example, the role 332 of the object 322), without itself containing information about the role.

Also, the master data object 325 may include attributes 336, along with roles 338. The object 325 illustrates that fact that the attributes 336 may be stored in a generic way, without necessarily requiring input from an object core for defining semantics of the attributes. In some implementations, every attribute that occurs in the context of a role may be exclusively stored at or within an associated object(s) and included in the object model 302, although the context and behavior of such an attribute may defined by the associated role(s).

In FIG. 3, and optionally in FIG. 1, objects may include attributes that are stored at, and/or define, a database layer of the corresponding data management system. Storing the object attributes at the database layer may imply their persistence in the manner discussed above, as well as a difficulty in modifying the object attributes. In contrast, roles and their attributes need not be stored as database objects, but may be stored as interfaces within a data repository as dictionary entries that interact with their defined attributes to define contracts for interacting with the applications.

It should be understood from the above discussion of FIG. 1 that components of the master data management system 300 may be used to create, modify, and use the roles 328, 330, 332, and 338, in the manner described above. For example, the harmonizer 316 and/or consolidator 314 may be used to assign object attributes from the object model 302 to specific roles, based on requirements of the application(s) 304, 306, and/or 308 that may ultimately use those attributes.

In this way, the various applications may easily know which roles to invoke, and how to invoke them, to obtain a desired service or behavior, without requiring knowledge of any object(s) associated with the roles. Moreover, modifications to a role may be made with respect to (only those) applications that will actually access the roles, and without respect to the object from which the role was derived (or to which the role is related).

Thus, the master data management system 300 is designed to allow users to access, manage, and manipulate data in a consistent and efficient manner. Existing master data management systems may suffer from many of the shortcomings discussed above, e.g., the need for complex and cumbersome objects, the possibility of mistakenly modifying data associated with such objects, a difficulty in accessing object functionality, and/or a difficulty in modifying an object model. In particular, in the context of the master data management system 300, it should be understood that, given the goal of the master data management system 300 to unify data throughout an organization, users may expect universal definition and application of objects within their particular system landscape. Accordingly, the use of roles in implementing object functionality, relationships, and interfaces, as described herein, may be useful in meeting customer expectations and understanding of “master data” within the context of the master data management system 300.

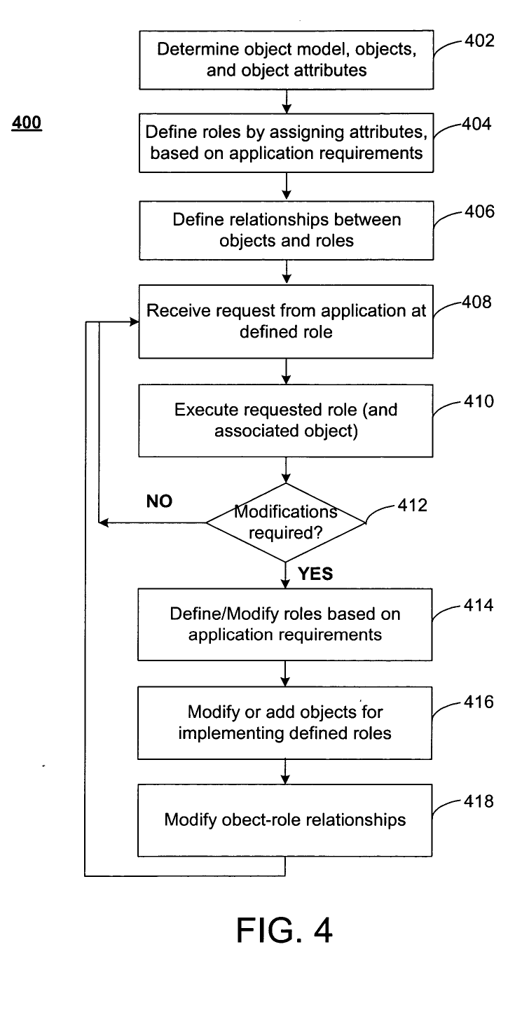

FIG. 4 is a flowchart 400 illustrating operations of the data management systems of FIGS. 1 and 3. In FIG. 4, a desired object model and associated objects for the data management system(s) are determined for a particular setting or context (for example, for a particular business or business function) (402). Subsequently, or simultaneously, roles are defined that are included within, or associated with, the objects of the object model (404). For example, attributes of the objects may be assigned to the roles, based on requirements of those applications that are anticipated to be using those roles (attributes). In this way, information as to which role (and its attributes) is to be used by which application may be easily determined and/or maintained. Moreover, the role and its assigned attributes define an interface that is particular to the application(s) that will be interacting with the role.

Relationships may then be defined (406). In some implementations, all relationships will be defined between the roles, so as to minimize the design requirements of the objects themselves. However, relationships also may be defined between the objects, or between objects and roles. Relationships include, and may be defined by, the manner in which, and the extent to which, attributes are shared between a given object and its associated role(s).

The data management system receives a request from an application for one of the roles (408). As should be understood from the above description, the application does not typically need to know which attributes it requires; rather, the application merely requires the ability to interact with a desired and defined role, so that the necessary attributes are automatically provided to the application.

The data management system then executes the requested role (410) so as to provide a desired functionality, behavior, or service to the requesting application. The requested role may interact with its associated object(s), or with other roles, in order to obtain the necessary data and methods to satisfactorily interact with the requesting application.

Once the functionality has been provided, and if no modifications are required (412), then the data management system may wait for any subsequent request(s) (408). If modifications are required (412), then new roles may be defined, or existing roles modified (414). As described, such changes to the roles are less problematic than would be changes to the object model or objects themselves, since it is known which applications make use of the roles being changed. As a result, role modifications that inadvertently affect non-related applications may be reduced or eliminated.

Further, the roles are de-coupled from, and generally independent of, their associated objects, at least for the purposes of interacting with applications as described herein. As such, changes to the roles and their role attributes do not generally affect the associated objects, so that roles may be enhanced or otherwise modified by, for example, adding new role attributes that do not need to added to respective objects.

There also may be situations where it becomes necessary or expedient to modify the objects (416), such as when, for example, no object currently exists that is capable of interacting with a particular role to provide a desired function. As another example, it may be the case that a data management system is modified from a database implementation (i.e., layout) to a catalog implementation, or is otherwise modified to, for example, change an underlying object model. In such cases, it should be understood that changes to the objects may be made without requiring modification or update to the applications (or their data management interfaces), since the applications generally interact only with their required roles.

Once all role or object modifications are made, relationships between the roles, between the object, or between the objects and roles, also may be modified, as needed (418). For example, a validation, harmonization, or consolidation may be run to ensure that attributes and/or attribute values are appropriately shared (e.g., synchronized) between roles and objects. Then, the data management system may continue to wait for a request from an associated application (408).

Although the use of roles in association with objects of an object model is discussed above with respect to a particular collection or landscape of systems, it should be understood that such roles may be used in other contexts, as well. For example, in some implementations, an object may be defined with respect to, and used within, a defined system landscape. It may be the case that external systems, outside of the defined landscape, may require access to a variation of the object and/or its functionality. In such cases, an object may be defined for use within the system landscape, while a related role may be defined for access by the external system(s).

For example, the master data management system 300 of FIG. 3 may be used in a global trade scenario, in which the master data object 324 corresponds to a particular product for sale. The product may be defined a certain way within an internal system landscape of the user of the master data management system 300.

However, a modified definition may be required when information about the product is exchanged outside of the system landscape. For example, if the product is sold in a first country, particular information, such as, for example, tax information or shipping information, may need to be associated with the product, where this information may be different or inapplicable when selling in the product in a second country.

In this context, a role associated with global trade scenarios may be associated with the product object, or with one or more product objects derived from the product object. In this way, global trade partners may access the global trade role and/or object, without regard to information that is not applicable to their context. Meanwhile, users internal to the system landscape may interact directly with the original product object, or with a role that is particular to the product object. In this way, internal data may more easily remain synchronized, and may more easily be synchronized with external data, as well.

As described above, a role entity may be used in a data object concept, such as in, for example, master data. In some implementations, such an object includes a core object and a role object, or a behavior component. In these implementations, some or all interactions between an application and the object take place over the role(s), and some or all relationships are defined as relationships between roles.

A number of implementations have been described. Nevertheless, it will be understood that various modifications may be made. Accordingly, other implementations are within the scope of the following claims.

1. An apparatus comprising a storage medium having instructions stored thereon, the instructions including:
a first code segment for maintaining a plurality of software objects, including an object representing an abstraction of an entity and having a plurality of object attributes that characterize the object and the entity;
a second code segment for maintaining a plurality of roles, including a role having a plurality of role attributes derived from the object attributes based on requirements of a requesting application, and operable to provide a functionality to the requesting application to fulfill the requirements; and
a third code segment for receiving a request from the requesting application at the role and providing the functionality to the requesting application, using the role and independently of any interaction between the object and the application.

2. The apparatus of claim 1 comprising a fourth code segment for maintaining relationship information describing relationships between the objects and the roles, based on the object attributes and the role attributes.

3. The apparatus of claim 1 comprising a fourth code segment for adding additional role attributes to the role attributes, independently of the object attributes and based on the requirements of the requesting application.

4. The apparatus of claim 1 comprising a fourth code segment for modifying the role attributes, independently of the object attributes and based on the requirements of the requesting application.

5. The apparatus of claim 1 comprising a fourth code segment for modifying the object attributes, independently of the role attributes.

6. The apparatus of claim 1 comprising a fourth code segment including persistence rules for maintaining the object across multiple sessions.

7. The apparatus of claim 6 comprising a fifth code segment for modifying a selected one of the roles independently of the persistence rules.

8. The apparatus of claim 1 comprising a fourth code segment for maintaining an object model that organizes and defines the objects.

9. The apparatus of claim 1 wherein all interaction between the software objects and the application occurs through the roles.

10. A method comprising:
inputting an object representing an abstraction of an entity and having a plurality of object attributes characterizing the object and the entity;
defining a role by deriving role attributes from the object attributes, based on requirements of an application; and
providing a service to the application to fulfill the requirements, using the role and independently of any communication between the object and the application.

11. The method of claim 10 wherein providing the service comprises:
receiving a request from the application at the role;
accessing the object to obtain object attribute information; and
providing the service to the application, based on the object attribute information.

12. The method of claim 11 wherein accessing the object comprises selecting the object from among a plurality of objects that are associated with the role.

13. The method of claim 12 wherein selecting the object comprises determining required object attributes required by the role to provide the service to the application.

14. The method of claim 11 wherein accessing the object comprises invoking the object according to persistence rules associated with the object.

15. The method of claim 14 wherein providing the service to the application comprises maintaining the role separately from the persistence rules associated with the object.

16. The method of claim 10 comprising adding additional role attributes to the role attributes, independently of the object attributes and based on the requirements of the application.

17. The method of claim 10 comprising modifying the role attributes, independently of the object attributes and based on the requirements of the application.

18. The method of claim 10 comprising modifying the object attributes, independently of the role attributes.

19. The method of claim 10 wherein providing the service comprises conducting all communication between the object and the application through the role.

20. A system comprising:
an object modifier operable to modify object attributes of an object selected from among a plurality of objects that represent abstractions of entities; and
a role modifier operable to modify role attributes, wherein the role attributes partially define a role interface for interfacing with an application to provide a service to the application, independently of communications between the object and the application.

21. The system of claim 20 wherein the role modifier is operable to modify the role attributes based on requirements of the application for providing the service to the application.

22. The system of claim 21 wherein the role modifier is operable to derive the role attributes from the object attributes, based on the requirements.

23. The system of claim 20 wherein the object modifier is operable to modify the objects independently of the roles.

24. The system of claim 20 wherein the role modifier is operable to modify the roles independently of the objects.

25. The system of claim 20 wherein the system includes a master data management system that is operable to provide an object model that includes the objects and the roles and that enables a common use of the objects or the roles to a plurality of applications or systems.

26. The system of claim 25 wherein the master data management system comprises:
a content consolidator that is operable to consolidate objects uploaded from the systems or applications; and
a harmonizer that is operable to ensure consistency of data within the objects or the roles, throughout the systems or applications.
